(19) United States
(12) Patent Application Publication
(10) Pub. No.: US 2012/0127855 A1
(43) Pub. Date: May 24, 2012

(54) METHOD AND DEVICE FOR CONVEYING TRAFFIC

(75) Inventors: Zehavit Alon, Raanana (IL); Nurit Sprecher, Petach Tikva (IL)

(73) Assignee: NOKIA SIEMENS NETWORKS OY, Espoo (FI)

(21) Appl. No.: 13/383,329

(22) PCT Filed: Jul. 10, 2009
(86) PCT No.: PCT/EP2009/058794

§ 371 Date: Jan. 10, 2012

(51) Int. Cl. H04L 12/24

(52) U.S. Cl. 370/218

(57) ABSTRACT

A method and a device for conveying traffic are provided, wherein a master node is connected to a first slave node and to a second slave node; wherein the first slave node and the second slave node comprise a connection; wherein traffic is conveyed between the master node and the first slave node; and wherein in case of a fault condition the traffic is conveyed between the master node and the first slave node via the second slave node and the direct connection between the first slave node and the second slave node. Furthermore, a communication system is suggested comprising said device.

The invention relates to a method and to a device for conveying traffic. Also, a communication system comprising such device is suggested.

Interconnected packet networks may comprise a customer network and a service provider network. An end-to-end service connection can span several such interconnected packet networks.

Each network can deploy a different packet transport technology for delivering Carrier Ethernet services. Interfaces used to interconnect the networks can be based on IEEE 802.3 MAC and packets that are transmitted over the interfaces can be Ethernet frames (according to IEEE 802.3/802.1). Ethernet frames may be transported via various transport technologies, for example, via ETH (Ethernet), GFP (Generic Framing Procedure), WDM (Wavelength Division Multiplexing), or via ETH/ETY (Ethernet Physical Layer).

Reliability in terms of quality and availability is a key feature of a Carrier Ethernet service. Service guarantees provided as Service Level Agreements (SLAB) require a resilient network that rapidly detects a failure or a degradation of any facility (interface or node) and restores network operation in accordance with the terms of the SLA. Network survivability is important for delivering reliable services.

The problem to be solved is to efficiently protect at least one service, e.g., Carrier Ethernet services, from a single point of failure, or from a single point of facility (node or interface) degradation, in particular along the path over which the at least one service is delivered in an Ethernet protection domain.

This problem is solved according to the features of the independent claims. Further embodiments result from the depending claims.

In order to overcome this problem, a method for conveying traffic is provided
wherein a master node is connected to a first slave node and to a second slave node;
wherein the first slave node and the second slave node comprise a connection;
wherein traffic is conveyed between the master node and the first slave node;
wherein in case of a fault condition the traffic is conveyed between the master node and the first slave node via the second slave node and the direct connection between the first slave node and the second slave node.

The connection between the first slave node and the second slave node can be a direct connection or an indirect connection, e.g., via a (protected) network or a portion thereof.

It is noted that any node referred to herein may be a network element or network component. Furthermore, the master node may be a node at the edge of a first network and the slave nodes both may be deployed at the edge of a second network. The direct connection between the slave nodes thus is a direct connection within the second network. The connection between the master node and the slave nodes, their interfaces and the direct connection may define an interconnected zone.

It is also noted that the interface of a node is also referred to as port. It is further noted that more than two slave nodes can be utilized accordingly.

It is also noted that a node through which traffic crosses from an attached network into an interconnected zone is referred to as “Traffic Gateway”.

The bypass feature reaching the first slave node via the second slave node allows maintaining a Traffic Gateway function with the first slave node without any need to change the topology of the network to which the slave nodes are attached. Hence, the interconnected zone can be utilized in an efficient way with a reduced impact to the networks connected to this interconnected zone. As the interconnected zone allows connecting networks of different technology, this approach bears the advantage of a robust, flexible and self-organizing connection.

It is an advantage that the concept suggested allows for load sharing of traffic between the nodes. Hence, in case of normal operation (without any fault condition), the traffic can be transmitted via separate VLANs, wherein each VLAN may utilize only one connection between the master node and the slave nodes. Hence, depending on the role (master, deputy, slave) the nodes are assigned to for each VLAN, the traffic can be efficiently distributed among different connections.

Herewith a solution is provided for a single point of failure or for a single point of facility (node or interface) degradation in an interconnected zone between packet networks. Each packet network may rely on a different packet technology (e.g., Bridged Ethernet, Traffic Engineered Ethernet, Layer 2 Multiprotocol Label Switching (L2-MPLS), MPLS-Transport Profile (MPLS-TP), etc.), which provides its own mechanism(s) to ensure network survivability. Hence, the interconnected zone between such networks of different technologies can be equipped with a mechanism that is capable of rapidly detecting a failure or facility (node or interface) degradation in this interconnected zone and/or restoring traffic without disrupting the service provided to an end user.

To ensure that there is no node representing a single point of failure, the interconnected zone may be construed such that transmission of a Carrier Ethernet service over the interconnected zone via two different nodes residing on either side of the zone is enabled. Each of the four nodes can be connected to the two nodes on the other side of the interconnected zone.

In an embodiment, the master node is connected via a first interface to the first slave node and via a second interface to the second slave node.

The first interface may be a working port and the second interface may be a protection port that can be activated in case of a fault condition.

According to a embodiment, the second slave node triggers the decision to become an intermediate node for conveying said traffic.

It is thus a decision made by the second slave node to become the intermediate node in the bypass route and in particular (not) to become a Traffic Gateway.

In another embodiment, the master node is associated with a first network and the first slave node and the second slave node are associated with a second network.

In a further embodiment, a deputy node is connected to the first slave node and to the second slave node and in case of the fault condition, the deputy node takes over for the master node.

In case the deputy node takes over for the master node, it may take over its configuration, role and/or functionality (at least in part) and it may perform the same activities as does (did) the master node. Hence, in particular bypassing traffic as described herein may work from the deputy node to any slave node via the other slave node as described for the master node. For example, in case the fault condition occurs, the traffic is conveyed between the deputy node and the first slave node via the second slave node and the direct connection between the first slave node and the second slave node.

Hence, the deputy node takes over the role of the master node. In particular, a switch-over from the master node to the deputy node is provided. Such switch-over can be initiated or triggered by the master node, by the deputy node, by a slave node or by OAM.

The deputy node may be a redundant node or a protection node than can replace the master node if necessary. There are various scenarios of such replacement, e.g., failure of the master node, failure of a port of the master node, failure of the link (e.g., between the master node and the slave node). Also, a degradation can be monitored and upon reaching a predetermined threshold, the deputy may take over for the master node. This efficiently allows determining a failure before it actually occurs, e.g., by detecting an increasing delay or the like.

The deputy node may be informed by the slave node or by the master node about the fault condition which triggers the switch-over from the master node to the deputy node. Such switch-over, however, may also be initiated by the deputy node itself when determining the fault condition.

Hence, upon detection of the fault condition, the deputy node may at least temporarily replace the master node. In particular, dependent on the actual fault condition, the traffic can be conveyed via the other interface of the master node or the master node's functionality may be switched over to the deputy node. The deputy node will in particular replace the master node, if the master node is defect.

The deputy node and the master node are associated with the same network and are in particular edge nodes of such network.

In a next embodiment, the master node and the deputy node are directly and/or indirectly connected.

It is also an option that the master node and the deputy node are connected indirectly, e.g., via several network elements of the network they are attached to. It is noted, however, that this may also apply for the connection between the slave nodes, for the connection between the master node and the slave node(s) and for the connection between the deputy node and the slave node(s).

Such direct connection between the master node and the deputy node can be used to inform the respective other node about the node's status. Such status information may comprise information regarding a forwarding state of the node and/or any of its ports directed towards the slave nodes.

It is noted that the internal link between the master node and the deputy node may be used for transmitting Ethernet data traffic and/or for transmitting control messages (e.g. OAM).

It is also an embodiment that the master node and the deputy node each comprise three interfaces as follows:
a working interface that is connected to the first slave node;
a protection interface that is connected to the second slave node; and
an internal interface.

The internal interface can be used to connect the master node and the deputy node. It is noted, however, that the master node and the deputy node advantageously are associated with a first network and the two slave nodes are associated with a second network. All nodes (master, deputy and slave) may be edge nodes of the respective networks.

It is noted that instead of direct connectivity between the master node, slave nodes and deputy node, also (at least some of) those nodes may be indirectly connected via a protection domain, e.g., a network or a portion thereof. Such connection may be provide via at least one intermediate node of such a protection domain. In particular, different paths throughout the protection domain can be used for such purpose.

Pursuant to another embodiment, the master node or the deputy node pursuant to the fault condition conveys traffic by switching over from its working interface to its protection interface or from its protection interface to its working interface.

According to another embodiment, after the fault condition is over, the traffic is conveyed as it was prior to the fault condition.

Hence, a switch-over from the deputy node to the master node may be done after the fault condition that led to the switch-over from the master node to the deputy node is solved. This may be an example for a revertive mode.

However, such revertive mode is an option and it may also be a solution to not reactivate the master node and maintain the operation via the deputy node (this scenario is an example for a non-revertive mode).

Hence, the traffic stream may be maintained even in case the fault condition is over. It is also an option, that the master node and the deputy switch roles, e.g., the deputy node may become the master node after the deputy node has been activated.

According to another embodiment, the fault condition comprises or is based on a failure or degradation of an interface or node, in particular comprising at least one of the following:
a link failure;
an interface failure;
a remote interface failure;
a remote node failure;
an administrative operation.

The fault condition may be determined by the master node, by the deputy node or by a slave node. The fault condition may directly or indirectly trigger protection switching, e.g., activating a redundant interface at the master node or at the deputy node or switching-over from the master node to the deputy node. The fault condition determined may be conveyed, e.g., by the slave node to the master node or to the deputy node. The master node or the deputy node may by itself determine a fault condition and trigger protection switching.

In yet another embodiment, traffic is conveyed via a virtual local area network (VLAN).

The solution provided, however, can be used by other protocols that have tags or labels to identify a specific (portion of) traffic, e.g., MPLS or MPLS-Transport Profile (MPLS-TP).

Hence, the traffic conveyed between the nodes mentioned is associated with a VLAN. The physical structure and its connections can be utilized by different VLANs, wherein each node (master node, deputy node or slave node) may be assigned a different role per each VLAN. This allows for an efficient load sharing of traffic across the interconnected zone, as different VLANs may use different nodes for different purposes. Also, protection switching is enabled for such VLANs in case a failure condition occurs.

The protection mechanism described herein is applicable to tagged or untagged Ethernet traffic.

According to a next embodiment, a portion of traffic is conveyed via a separate virtual local area network.

Pursuant to yet an embodiment, said traffic is an Ethernet traffic in particular comprising Ethernet frames.

According to yet another embodiment, the fault condition is determined by the master node, by the deputy node or by a slave node.

Such fault condition determined may trigger an information to be provided, e.g., to the master node or to the deputy node. The master node may thus switch to the deputy node or the deputy node may activate itself. As an option, the deputy node may deactivate the master node.

The fault condition may relate to a port, to a node or to both. Hence, the master node when determining a fault condition at one of its active ports may switch to an inactive port, activate this port and thus convey the traffic via this newly activated port.

This scenario applies for the deputy node as well. Once the deputy node is being activated (either by a message from a slave node, by a message from the master node or by itself recognizing that the master node is inactive), the deputy node may utilize its ports as described for the master node and thus may provide protection switching between its ports if necessary.

The problem stated above is also solved by a device comprising and/or being associated with a processor unit and/or a hard-wired circuit and/or a logic device that is arranged such that the method as described herein is executable thereon.

According to an embodiment, the device is a communication device, in particular a or being associated with a network element associated with the network or an edge node of the network.

The problem stated supra is further solved by a communication system comprising the device as described herein.

Embodiments of the invention are shown and illustrated in the following figures:

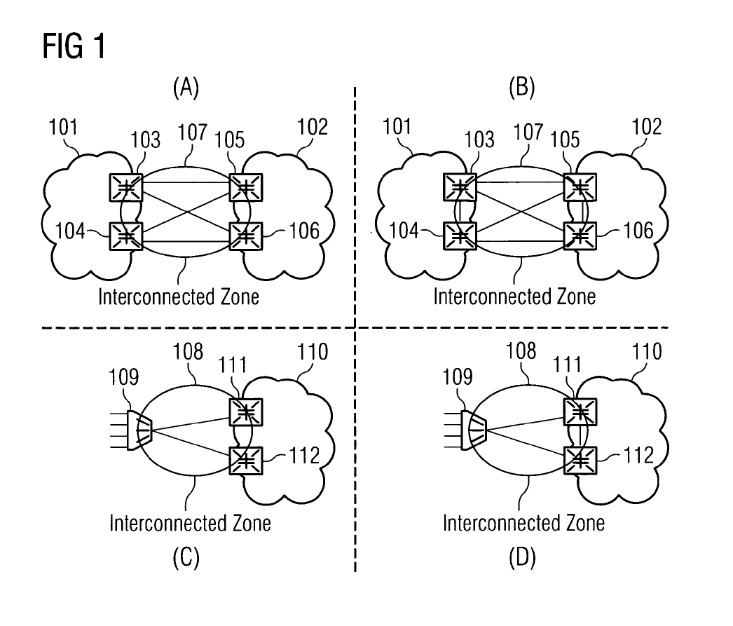

FIG. 1 shows examples of interconnected zones between networks;

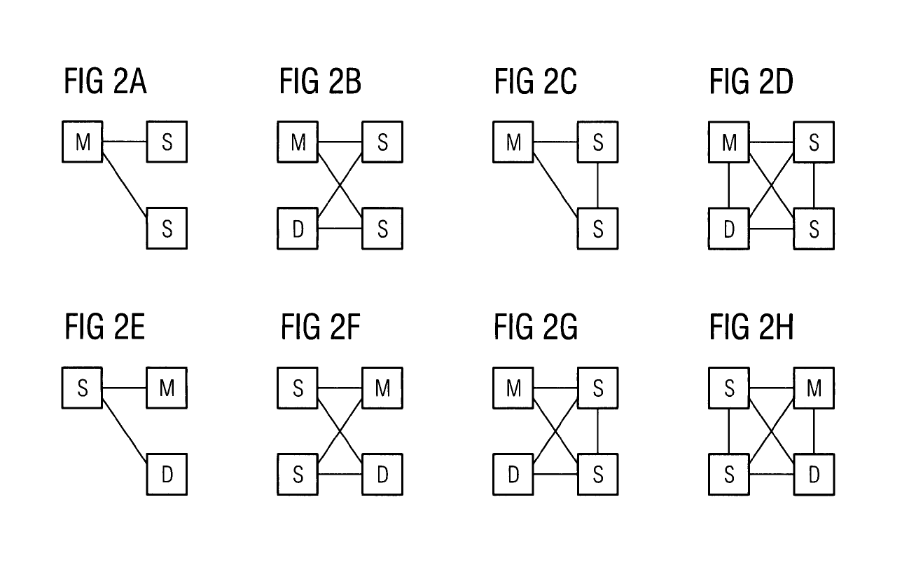

FIG. 2 shows different node functionalities provided by nodes associated within the interconnected zone;

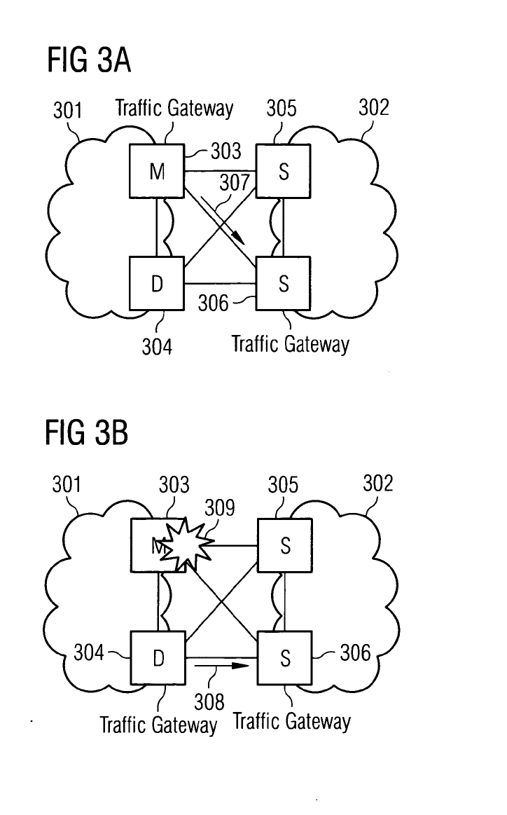

FIG. 3 shows an example of traffic being conveyed across an interconnected zone, wherein after a master node failure a deputy node takes over the role of the master node;

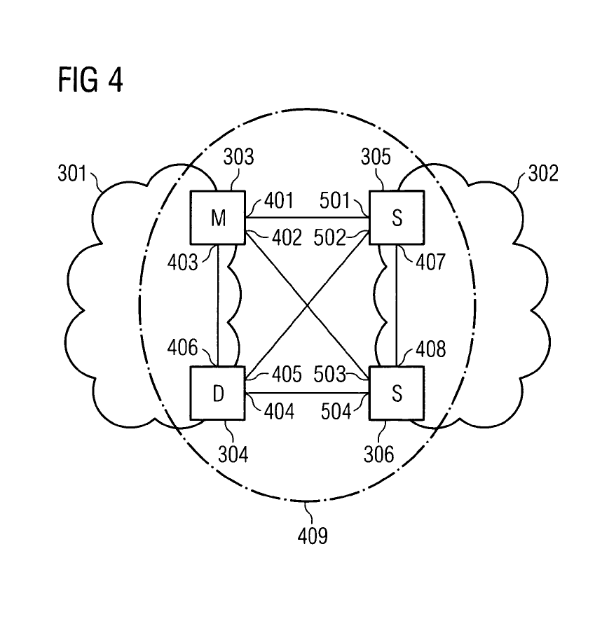

FIG. 4 shows an exemplary port description, wherein a master node and a deputy node are attached to a first network and two slave nodes are attached to a second network and wherein the master node and deputy node each are connected to both slave nodes via an interconnected zone;

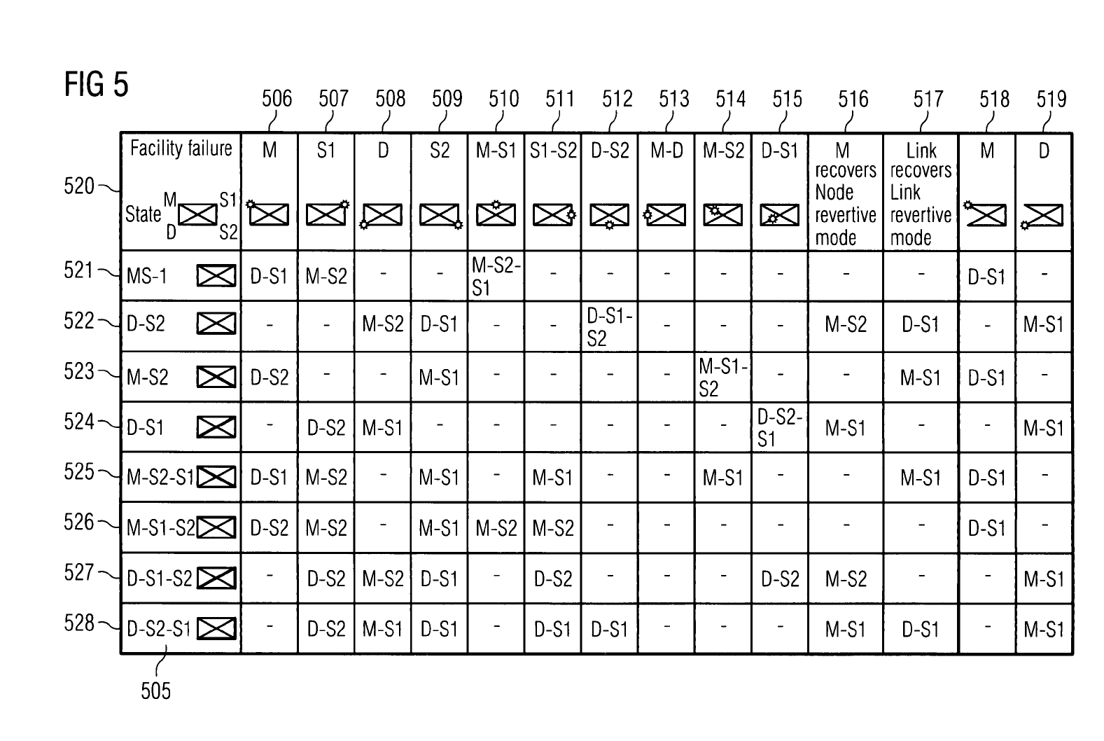

FIG. 5 shows a transition table comprising combinations of Traffic Gateways and links that are used for conveying traffic across the interconnected zone as well as new Traffic Gateways and links after different kinds of failures;

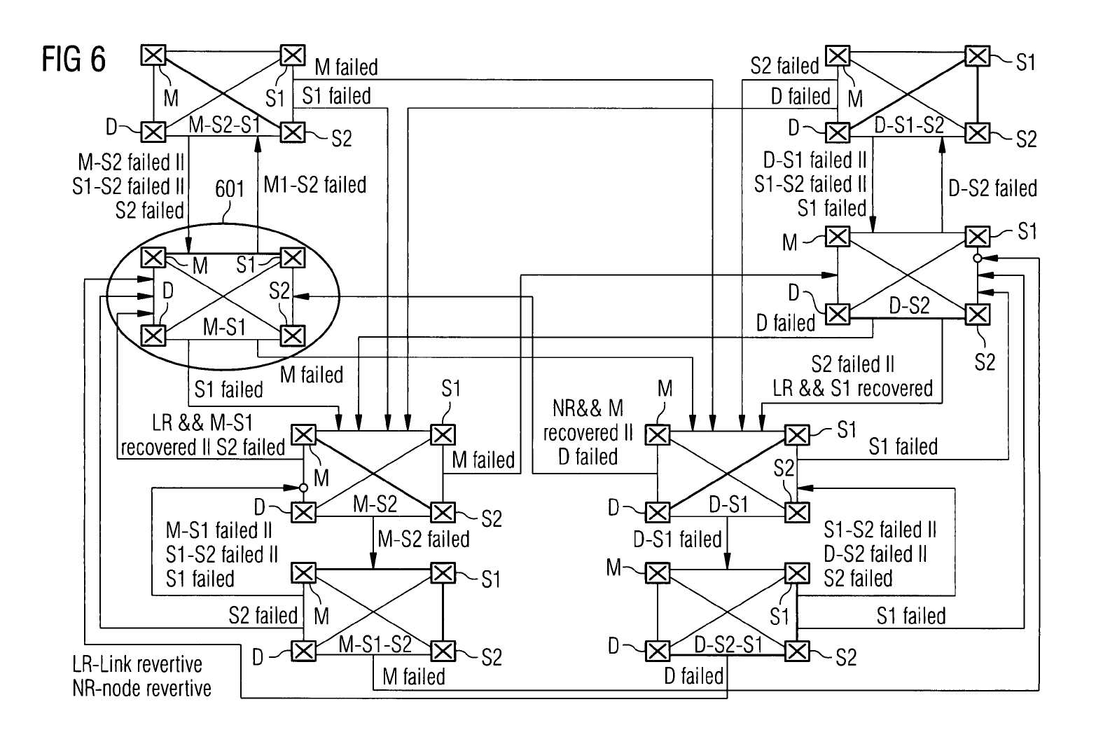

FIG. 6 shows a flow chart illustrating data flows and transitions between the flows that may result from different types of failures

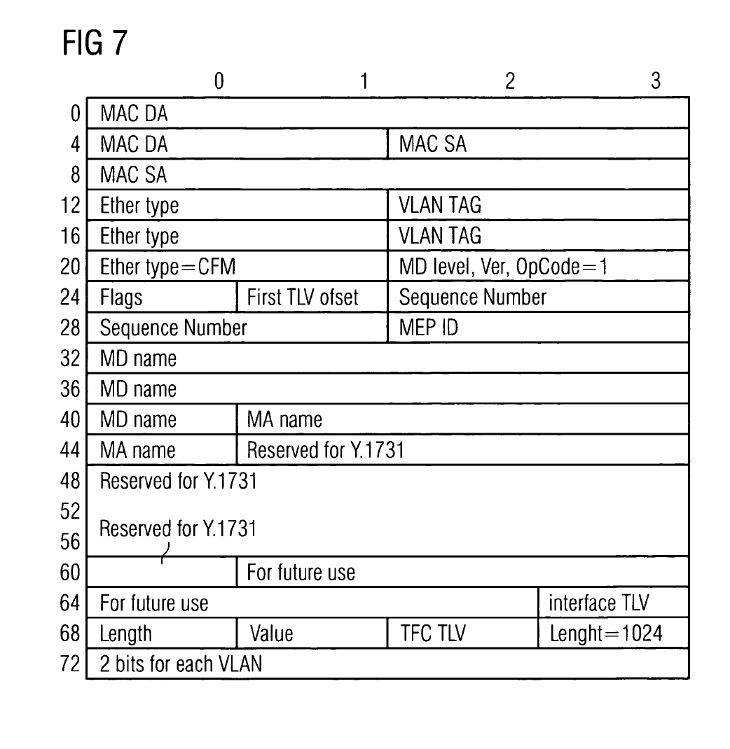

FIG. 7 shows a proposed structure for a TFC TLV based on IEEE 802.1ag CCM.

FIG. 1 shows examples of interconnected zones.

In a scenario (A), a network 101 is connected to a network 102, wherein the network 101 comprises two nodes 103, 104 and the network 102 comprises two nodes 105, 106. Each node has two interfaces (also referred to as ports), wherein the node 103 is connected to the node 105 and to the node 106; also, the node 104 is connected to the node 105 and to the node 106. An interconnected zone 107 comprises said nodes and the connections to the respective other network. The interconnected zone 107 is used to transmit Carrier Ethernet services in a reliable way without a single point of failure or degradation. This type of scenario is referred to as a “2×2 Attached” interconnected zone.

In a scenario (C), a node 109 (comprising two interfaces) is connected to two nodes 111, 112, which are edge nodes of a network 110. An interconnected zone 108 is used to transmit Carrier Ethernet services via the single node 109 located on one side of the interconnected zone 108 to two attached nodes 111, 112 on the other side of the interconnected zone 108. An example of such a construction is a Digital Subscriber Line Access Multiplexer (DSLAM), which is attached through two nodes to a service provider network. This type of scenario is referred to as a “1×2 Attached” interconnected zone (also referred to as “dually-attached” interconnected zone).

The mechanism suggested allows for a rapid detection of a fault condition or failure or a degradation condition as well as a fast recovery (in less than 50 ms). It also allows the service provider to utilize resources in the interconnected zone in an efficient manner thereby enabling load sharing of the traffic to be conveyed.

This mechanism is applicable to any MEF (Metro Ethernet Forum) service, such as EPL (Ethernet Private Line), EVPL (Ethernet Virtual Private Line), EP-LAN (Ethernet Private LAN), EVP-LAN (Ethernet Virtual Private LAN), EP-Tree (Ethernet Private Tree), or EVP-Tree (Ethernet Virtual Private Tree).

The Ethernet frames used for conveying Ethernet traffic over interfaces in the interconnected zone may be based on or as defined in IEEE 802.1D, IEEE 802.1Q, IEEE 802.1ad or IEEE 802.1ah.

The interconnected zones 107 and 108 as shown in scenarios (A) and (C) of FIG. 1 in particular bear the following advantages:
A direct (single-hop) connectivity is provided between the attached networks. This ensures a short path and a low latency when traffic is being transmitted between the attached networks.
Efficient load sharing across all the (direct) links in the interconnected zone is enabled thereby allowing for an efficient utilization of the resources deployed in the interconnected zone.

It is noted that the mechanism suggested can be used in any protection domain or network working as interconnected zone, wherein such protection domain may also comprise indirect links, e.g., via intermediate network elements of this protection domain.

However, a side effect of this mechanism is that every protection event (i.e. switchover or revert) of the interconnected zone affects the topology of at least one of the attacked networks. A switchover resulting from a link failure, for example, causes the traffic in the interconnected zone to be redirected through another link and another node. The topology of the attached network to which this node belongs may thus change accordingly, in order to allow for the traffic to be redirected from the network to the interconnected zone via the new active node.

Hence, Carrier Ethernet services may be further protected by utilizing interconnected zones as shown in scenarios (B) and (D) of FIG. 1.

Scenario (B) is based on scenario (A), the components are identical and are described with regard to scenario (A). However, scenario (B) comprises a connection between the nodes 103 and 104 of the network 101 and a connection between the nodes 105 and 106 of the network 102.

It may also be a scenario (not shown) where only the slave nodes are connected with one another, but the master node and the slave node are not directly connected with each other.

Accordingly, scenario (D) stems from scenario (C), wherein the components are identical and are described with regard to scenario (C). In addition, scenario (D) comprises a connection between the nodes 111 and 112 of the network 110.

The connections between the nodes 103 and 104, between the nodes 105 and 106 and between the nodes 111 and 112 are referred to as “internal links” or “internal connection”.

These internal links help minimizing detrimental effects pursuant to protection events within the interconnected zone. In particular, an impact on topology changes within the attached networks can be significantly reduced.

Such detrimental effects may result from at least one of the following events:
(a) A failure of a node in the interconnected zone. Traffic that is transmitted prior to a failure event on that node needs to be redirected to the other node that resides in the same attached network. The topology of the attached network must be changed to allow traffic from that network to be directed via the new active node into the interconnected zone.
(b) Setting a revertive mode on the node forces a switchover when the node recovers from its fault condition. This affects the topology of the related attached network, as traffic from the attached network to the interconnected zone needs to be redirected to this (re-)activated node (i.e. a master node).
(c) An administrative command to switch over to the protection node (referred to as deputy node).

On the other hand, when a link fails in the interconnected zone (because of a fault or degradation), traffic can be transmitted between the two nodes (that are connected by the failed link) via a route that bypasses the failed link. Hence, the topologies of the attached networks are not affected by the protection event in the interconnected zone.

A node through which traffic crosses from an attached network into an interconnected zone is referred to as “Traffic Gateway”. At any time, only one node (in each attached network) may serve as such Traffic Gateway for its attached network.

As long as a protection event in the interconnected zone does not cause a change in the Traffic Gateway, the topology of the related attached network is not affected by the protection event. If the Traffic Gateway itself fails, a new Traffic Gateway may take over, wherein such event affects (as described above) the topology of the attached network.

Pursuant to scenario (B) of FIG. 1, traffic is transmitted between the networks 101 and 102 via nodes 103 and 105. These nodes 103 and 105 may serve as Traffic Gateways for the attached networks 101 and 102 as well as for the interconnected zone 107.

If the link between node 103 and node 105 fails, the traffic will be transmitted between the nodes 103 and 105 via another route which bypasses this failed link. Such bypass route can be as follows: From the node 103 via the node 106 to the node 105. In this case, the node 106 is not used as a Traffic Gateway, but as an intermediate node in the bypass route between the Traffic Gateways 103 and 105.

The decision to create this bypass route may be made by the slave node. The master node may decide to convey traffic via a different link. The second slave node may decide not to become a Traffic Gateway, but to serve as an intermediated node of the bypass route and to keep the first slave node as the Traffic Gateway. Hence, a slave node as an intermediate node of the bypass route may decide to process traffic via said bypass route.

If the Traffic Gateway fails, traffic can be transmitted via a new Traffic Gateway. For example, according to scenario (B) of FIG. 1 traffic may be conveyed between nodes 103 and 105, both nodes acting as traffic gateways. In case node 105 fails, the topology of the attached network 102 is affected, as traffic can no longer be conveyed across this node 105. Accordingly, the node 106 may become the Traffic Gateway for the network 102. Hence, the traffic is directed from the node 103 to this new Traffic Gateway 106. It is noted that the topology of the network 101 is not affected by this protection event, because the node 103 acting as Traffic Gateway for the network 101 remains unchanged.

The mechanism described herein may benefit from the type of interconnected zone as shown in the scenarios of FIG. 1. The approach provided supports all four scenarios of interconnected zones depicted in FIG. 1, i.e. the “2×2 Attached” type according to scenario (A), the “Full Mesh 2×2 Attached” type according to scenario (B), the “1×2 Attached” type according to scenario (C) and the “Full mesh 1×2 Attached” type according to scenario (D).

It is further noted that the mechanism also supports inservice network upgrade from one type to another type.

The mechanism described herein can be used to protect Ethernet traffic flows in an interconnected zone. The interconnected zone can be based on one of the scenarios depicted in FIG. 1.

The protected traffic may be of any type of Carrier Ethernet service (E-Line, E-LAN, or E-Tree). The Ethernet frames used to carry Ethernet traffic over the interfaces in the interconnected zone may be based on or as defined in IEEE 802.1D, IEEE 802.1Q, IEEE 802.1ad or IEEE 802.1ah.

A traffic flow is transmitted over one of the interfaces connecting two adjacent networks. In the event of a fault condition on that interface, traffic is redirected through a bypass route (if available) between two Traffic Gateways. If a bypass route is not available (as in the interconnected zones depicted in the scenarios (A) and (C) of FIG. 1), traffic is redirected to a new Traffic Gateway through the redundant interface (in the scenarios (C) and (D); the node 109 has two interfaces, wherein one interface is a backup interface thereby allowing the node 109 to choose a different path via the backup interface in case the connection of the main interface fails or deteriorates).

If a Traffic Gateway is no longer able to transmit traffic in the “2×2 Attached” and in the “Full Mesh 2×2 Attached” interconnected zones (see scenarios (A) and (B) of FIG. 1), traffic can be redirected through a redundant Traffic Gateway.

The protected Ethernet traffic can be tagged or untagged. In case of tagged Ethernet traffic, protection can be implemented per VLAN, regardless of any other VLAN. It is noted that this solution may apply to an outer VLAN of a frame.

Traffic from various VLANs can be transmitted over different interfaces connecting the two adjacent networks. The (outer) VLAN can be of any of the following tags: a C-VLAN (customer VLAN), an S-VLAN (Service VLAN) or a B-VLAN (backbone VLAN).

In IEEE 802.1Q, IEEE 802.ad and IEEE 802.1ah switches, untagged traffic is tagged by a port VLAN identifier, which results in tagged traffic. In IEEE 802.1D switches, protection can be implemented on the entire traffic that is trans-mitted over the interface.

The protection mechanism described herein is applicable to tagged or untagged Ethernet traffic.

One of the nodes in an interconnected zone may operate as a master node. The master node is responsible for selecting the interface over which the relevant traffic will be transmitted, while the peer nodes in the attached network work as slave nodes following the master node's decision. However, it is noted (as indicated also above) that the slave node may make the decision whether to become a Traffic Gateway or to be an intermediate node within the bypass route and it may thus forward the traffic to the first slave node.

In the “2×2 Attached” type according to scenario (A) of FIG. 1 and in the “Full Mesh 2×2 Attached” type according to scenario (B) of FIG. 1, the master node is protected by a redundant node (also referred to as backup node or deputy node), which is attached to the same two slave nodes as the master node. If the master node fails, the deputy node acts as a substitute for the master node.

FIG. 2 shows different node functionalities provided by nodes associated within the interconnected zone. In FIG. 2 the following abbreviations are used: M refers to a master node, S refers to a slave node and D refers to a deputy node. Furthermore, to the left side a first network is attached and to the right side a second network is attached (the networks are not shown in FIG. 2) similar to the illustration of FIG. 1. Hence, the nodes depicted on the left are associated with the first network and the nodes depicted on the right are associated with the second network. These nodes may be edge nodes of the respective network and be connected via said interconnected zone.

FIG. 2A shows a dual attachment of a master node to two slave nodes and FIG. 2E shows a slave node being connected to a master node and to a deputy node. A scenario depicted in FIG. 2C corresponds to the one shown in FIG. 2A supplemented by a connection between the two slave nodes.

FIG. 2B shows a “2×2 Attached” scenario with a master node and a deputy node of a first network each connected to two slave nodes of a second network. FIG. 2D shows a “Full Mesh 2×2 Attached” scenario based on FIG. 2B with the master node and the deputy node being connected and with the two slave nodes being connected with one another. A scenario depicted in FIG. 2G corresponds to the one shown in FIG. 2D, wherein the master node and the slave node are not directly connected.

FIG. 2F corresponds to the mirrored scenario of FIG. 2B and FIG. 2H corresponds to the mirrored scenario of FIG. 2D.

The role of each node (master, deputy or slave) in an interconnected zone can be set by administrative configuration for each VLAN. Thus, a node may work as a master node for some VLANs and as a deputy node for another VLAN. As in normal operation (i.e. without any fault condition) only one path is used per VLAN for conveying traffic across the interconnected zone, different VLANs may use different paths. This allows for an efficient load sharing between the nodes of the interconnected zone.

The protection mechanism operates on a per-VLAN basis and is independent from other VLANs. The approach presented in particular refers to a protection of Ethernet traffic for a specific VLAN. The mechanism works accordingly for each VLAN in the interconnected zone.

For a specific VLAN, only one of the (direct) links between the adjacent networks may be used at a given time to forward traffic. Traffic may also be transmitted over the internal link between the slave nodes (if available) in order to preserve a Traffic Gateway and to bypass a failed or degraded link. It is noted that the internal link between the master node and the deputy node may be used for transmitting Ethernet data traffic and/or for transmitting control messages (e.g. OAM). These control messages allow the master node and the deputy node monitoring each other's status and to take an appropriate action in case a fault condition is detected.

A protected VLAN may be configured on one, on two or on three ports for each node in the interconnected zone. Two ports are used to connect the respective node with the two nodes of the adjacent network, while one (internal) port can be used to connect the node to the other node of the same network. As described above, in a specific VLAN, Ethernet traffic may be transmitted over one of the interfaces which connect the adjacent networks via the interconnected zone. Traffic may also be transmitted over the internal link between the slave nodes, bypassing a failed or degraded link, in an attempt to preserve a Traffic Gateway and to avoid a topology change in the attached network.

Each of the nodes in an interconnected zone may have a forwarding state for each VLAN. The forwarding state may indicate whether the node is “active” or “standby” with regard to Ethernet traffic in that VLAN. It is noted that a node being in “active” forwarding state works as a Traffic Gateway. For a specific VLAN, two nodes may work as Traffic Gateways, wherein one of these two nodes is either the master node or the deputy node, while the other node is a slave node. Moreover, each of the ports (on which that specific VLAN is configured) in an interconnected zone has a forwarding state relating to that VLAN, indicating whether the port is “active” or “standby” with regard to Ethernet traffic in that VLAN. A single port (out of maximum of three ports) of a Traffic Gateway may be in the “active” forwarding state.

When a bypass route is used to protect a failed or degraded link, two ports (out of the three ports) of the intermediate (slave) node are in the “active” forwarding state. One of these ports is the internal port through which the node is connected to the second slave node attached to the same network. It is noted that (only) a slave node may serve as an intermediate node on a bypass route in an interconnected zone. When a slave node serves as an intermediate node on such bypass route, its node forwarding state is “standby”, although the forwarding state of two of its ports is “active”.

Ethernet traffic received in a VLAN may be forwarded to the attached network only through a node and a port, which are in the “active” forwarding state. As explained above, traffic may be transmitted in the interconnected zone via a slave node that is in the “standby” forwarding state while two of its ports are in an “active” state. This scenario will be applicable, if the two slave nodes are directly or indirectly connected via an internal link (i.e. two slave nodes of one network being directly connected) and if one of the slave nodes serves as an intermediate node in a bypass route between two Traffic Gateways, i.e. between the other slave node and the active node (master node or deputy node).

In an interconnected zone, each port may communicate to its peer port in the interconnected zone (the one to which it is directly connected) the forwarding state (per VLAN) of the node to which it is associated as well as its own forwarding state.

Regarding the master node or the deputy node, one of its ports (that is connected to a slave node) is configured as a “working” port for the particular VLAN while the other port is configured as a “protection” port for this VLAN. Such configuration defines the port that is administratively preferred to be in the “active” forwarding state. It is noted that the master node and the deputy node may select the port over which traffic is to be sent. Such selection is of advantage in case it helps avoiding a change of topology in one of the attached networks pursuant to a protection event in the interconnected zone.

FIG. 3A shows a first network 301 comprising a master node 303 and a deputy node 304 as well as a second network 302 comprising a slave node 305 and a slave node 306. The master node 303 is connected via a first port to the slave node 305 and via a second port to the slave node 306. Also, the deputy node 304 is connected via a first port to the slave node 305 and via a second port to the slave node 306. In addition, the master node 303 and the deputy node 304 are directly connected with one another (via an internal port located at the master node 303 as well as at the deputy node 304) and the slave node 305 and the slave node 306 are directly connected with each other (via an internal port located at the slave node 305 and at the slave node 306).

In FIG. 3A traffic is transmitted from the master node 303 to the slave node 306 via the master's second port (also referred to as a protection port) in a link operating in a non-revertive mode. This transmission is indicated by an arrow 307.

FIG. 3B is based on FIG. 3A and indicates a failure 309 of the master node 303. To avoid any topology changes in the adjacent network 302 in such case of the master node being defective, the deputy node 304 takes over and sends the traffic via its second port (protection port) to the slave node 306, which serves as a Traffic Gateway. This is indicated by an arrow 308 in FIG. 3B.

FIG. 4 shows an exemplary port configuration. The reference numbers are at least partially identical to the ones shown in FIG. 3A and FIG. 3B and the explanations provided above apply accordingly. In addition, FIG. 4 shows the first port of the master node 303 being a working port 401 and the second port of the master node 303 being a protection port 402. Also, the master node 303 has an internal port 403. Similarly, the deputy node 304 has an internal port 406, a working port 405 and a protection port 404. The slave node 305 has an internal port 407 and the slave node 306 has an internal port 408. As indicated previously in FIG. 1, an area 409 is referred to as interconnected zone.

In addition, a revertive and a non-revertive mode for that VLAN can be configured. Such revertive mode can be supported on a node level and/or on a port level.

In the revertive mode on the node level, traffic is restored to the master node after the condition(s) that caused the switchover is/are solved. In the non-revertive mode on the node level, traffic remains with the deputy node after the problem that caused the switchover is solved.

It is noted that a revertive operation on the node level may cause a change of the Traffic Gateway and, as a result, it may also cause a change in the topology of the attached network. This should be taken into consideration when configuring the revertive mode on the node level. Reverting to a recovered node effectively re-enables the traffic loadbalancing capability.

In the revertive mode on the port level, traffic is restored to the “working” port after the condition(s) that caused the switchover is/are solved. In the non-revertive mode on the port level, traffic remains on the “protection” port after the condition(s) that caused the switchover is/are solved.

At any time, each node in an interconnected zone may determine ports that could be used to convey traffic. The decision can be made based on at least one of the following information:
A role of the node (i.e. master, deputy, or slave).
A role of the port in case of a master node or a deputy node. This role of the port may be “working”, “protection” or “internal”. For a slave node, a role of the port may be “internal”. The ports on the slave node that are not configured may be referred to as “port1” and “port2”.
A revertive or a non-revertive mode on the node level for a particular VLAN with regard to the master node.
A revertive or a non-revertive mode on the port level for a particular VLAN with regard to the master node and the deputy node.
A current forwarding state of the node.
A current forwarding state of the ports participating in the protection mechanism.
Forwarding states of the peer nodes and ports in the interconnected zone (as received over the (direct) interfaces), indicating the status of each port and node in the particular scenario, thereby indicating the location of the Traffic Gateway.

When the nodes start up under normal conditions (i.e. without any failure condition in the interconnected zone), the master node becomes the Traffic Gateway. The master node selects its “working” port for forwarding traffic and sets the “working” port's forwarding state to “active”, its “protection” port's forwarding state to “standby” and its “internal” port's forwarding state to “standby”. The forwarding states of the deputy node and of its ports are set to “standby” if the masters node's state is set to “active”.

If, for any reason (e.g., a port failure, a remote port failure, any degradation exceeding a predetermined threshold, etc.), the “working” port of the master node cannot forward traffic, the “protection” port is selected to forward traffic and its port forwarding state is set to “active”. The traffic is switched over to this “protection” port.

Depending on the revertive mode or non-revertive mode configured for the particular VLAN, the forwarding state of the “protection” port either changes to “standby” or remains “active” when the problem that led to the switchover is solved.

If the master node fails and if there is a deputy node available, the deputy node substitutes the master node and takes over its role. The deputy node becomes the Traffic Gateway. If the deputy node discovers that one of the slave nodes is the Traffic Gateway of the attached network, it may select the port that is connected to that particular slave node (acting as Traffic Gateway)—regardless of the configuration of the port connected to that slave node—setting the forwarding state of that port to “active”. If there is no slave node acting as a Traffic Gateway, the deputy node may select the configured working port as “active” port.

It is noted that the order of port preference for the master node and for the deputy node can be primarily determined based on the fact whether the remote slave node is or is not a Traffic Gateway; hence, the port may only be selected according to its preset configuration when none of the nodes is a Traffic Gateway.

If the master node fails and if there is no deputy node (as, e.g., in the “1×2 Attached” scenario), the traffic cannot be forwarded through the interconnected zone until the master node recovers. In such a scenario, the master node may be a single point of failure and the traffic may have to be dropped.

If the slave nodes are not directly connected with one another (via said internal link), they may adjust themselves according to the decisions provided by the active node (master node or deputy node).

When the slave nodes are directly connected via their internal ports and a slave node receives a request to forward traffic to a Traffic Gateway on the adjacent network (i.e. the slave node receives an indication from a peer node on the adjacent network that the forwarding states of its node and of the port through which it is connected to the slave node are “active”), it may perform at least one of the following steps:
(1) The slave node may check whether it is already connected to a Traffic Gateway (i.e. master node or deputy node). If the slave node is already connected to such Traffic Gateway, the slave node ignores the new request. It is noted that there may (temporarily) be two Traffic Gateways on the same network in parallel, e.g., in the event of a failure of the internal link, pursuant to which failure the master node and the deputy node may both be connected.
   As a fault condition on the internal link between the master node and the deputy node may not be distinguishable from a failure of the node itself, a redundant node (master or deputy) that does not hear from the other node (to which it is directly connected via the internal link), suspects that this other node has failed and the redundant node tries to take over.
   When the redundant node (trying to take over) realizes that the slave node does not correspond to the request and does not activate the port on which the request was received, it may recognize that there is another Traffic Gateway in its network and that connectivity to it has been lost due to a failure of the internal link.
   Then, the redundant node may revert and it may set its node forwarding state to “standby”. The redundant node may also set the forwarding state of the port through which it is connected to the slave node to “standby”.
   As a result, there might be a short time interval during which both, the master node and the deputy node, may send traffic to the slave node. However, the slave node may advantageously process traffic from its “active” port only and it may drop traffic received on the other port. In any case, traffic may not be received twice in the adjacent network (i.e. the network to which the slave node is connected).
(2) If the first slave node is not connected to a Traffic Gateway, the first slave node will check whether the second slave (connected via the internal port) is already operating as Traffic Gateway.
   If the second slave node operates as Traffic Gateway, the first slave node will not become a Traffic Gateway, but it will act as an intermediate node on a bypass route. Therefore, the first slave node retains its “standby” node forwarding state, sets the port forwarding state of the internal port to “active” and sets the forwarding state of the port via which it is connected to the adjacent network from which it received the request to “active”.
(3) If the second slave node is not a Traffic Gateway, the first slave node accepts the request (from the master node or from the deputy node) and becomes a Traffic Gateway. The first slave node sets the forwarding state of its node to “active” as well as the forwarding state of the port through which it received the request.

When the first slave node (whose node forwarding state is “active”) receives an indication that the forwarding state of the second slave node is “standby”, but its internal port's forwarding state is “active”, the first slave node becomes aware that the second slave node functions as an intermediate node on a bypass route that terminates on its own port. The first slave node thus sets the forwarding state of its internal port (through which it is connected to the second slave node) to “active”.

If there is no internal link between the master node and the deputy node and as long as the deputy node is aware that one of its peer (slave) nodes has an “active” forwarding state, the deputy node may conclude that the master node is active and can forward traffic. When the deputy node detects that none of the slave nodes is in an “active” forwarding state, it may conclude that the master node has failed to forward traffic and thus the deputy node may take over the master node's role by changing its forwarding state to “active” and by selecting one of its ports (preferably the “working” port) to forward traffic. The forwarding state of this “working” port is thus set to “active”. It is also possible that in this case the deputy node decides to utilize its “protection” port instead of the “working” port.

If the slave nodes are connected via the internal link with one another and if the slave node that serves as a Traffic Gateway does no longer receive any message from the adjacent network (i.e. from the master node or from the deputy node), this slave node will stop sending traffic to the interconnected zone although it retains its role as Traffic Gateway (hence, it may keep its node forwarding state “active” for a given period of time to indicate that it may be used as the Traffic Gateway). Such an intermediate state (i.e. when the slave node receives traffic from its attached network, but does not send it to the interconnected zone) pursues the objective to preserve (the location of) the Traffic Gateway and tries to avoid changes to be applied to the topology of its attached network. After such predetermined time period is over and if the slave node does not receive a request (from either the master node or the deputy node across the interconnected zone) to forward traffic via any of its ports, the slave node will renounce its role as Traffic Gateway and set its node forwarding state to “standby”. This functionality is in particular useful in case the master node and the deputy node are not connected with each other and thus are not able to directly detect a failure at the respective other node. Hence the failure can in this case be detected via the (behavior of the) slave nodes across the interconnected zone. When the redundant node (master node or deputy node) detects that there is no active slave node, it may conclude that there is no Traffic Gateway in its network and it therefore may set itself to become the Traffic Gateway.

It is noted, however, that the information regarding the forwarding conditions can be added to IEEE 802.1ag link-level CCM messages, which are sent to monitor a link. However, the approach provided may utilize any (regular or non-periodical) message that may convey the required information between the nodes.

Each node in the interconnected zone may have a functional entity referred to as a Traffic Forwarding Controller (TFC). The TFC is used to control the forwarding conditions (per VLAN) of the nodes that are connected in an interconnected zone, the ports that connect the nodes to the attached network and also the internal ports.

The TFC serves as a logical port that bundles the set of ports in a node which resides in the interconnected zone. It is noted that these bundled ports may not be considered as bridge ports. Instead, the TFC can be perceived as a bridge port according to a IEEE 802.1 bridge relay function and VLANs can be defined as members of the TFC, as defined on any other bridge port. The TFC may forward traffic to the appropriate underlying port and collect traffic from the underlying ports. Thus, MAC addresses can be learnt by the TFC instead of the underlying ports, which are controlled by the TFC.

The TFC is configured together with the VLANs to be handled and together with the underlying ports that are capable of forwarding this single VLAN (one, two or three port(s), if there is an internal port). VLAN traffic can be forwarded according to the IEEE 802.1 bridge relay function to the TFC (when it belongs to the member set of that VLAN), which in turn forwards it to the port which is in an “active” forwarding condition. If the TFC does not have a port with an “active” forwarding condition for that VLAN, the packets may be dropped. In case of a bypass node (the node forwarding state is “standby”), the VLAN traffic is received on one of the active ports and it is relayed directly to the other active port without passing through the bridge relay entity.

The TFC may keep information about each VLAN of which it is a member. This information comprises forwarding conditions of the node and ports for that VLAN. It may happen that the forwarding condition of a node for a particular VLAN is “active”, while it is “standby” for another VLAN.

It is noted that any bridge port (a physical port or a link aggregation (LAG) pursuant to IEEE 802.3ad) can be part of the TFC.

### Transition Table, Flow Chart

Each of the three types of nodes (master node, deputy node, slave node) has its own state machine. The state machines may reside in the TFC and can be defined per VLAN. Hence, a dedicated state machine can be provided for each protected VLAN. The state machine determines the forwarding state of the ports on which the VLAN is defined as well as the forwarding state of the node for that VLAN. The forwarding state may change as a result of events that occur locally in the node, remotely in the peer nodes or on the interfaces connecting the peer nodes.

FIG. 5 shows a transition table comprising combinations of Traffic Gateways and links that are used for conveying traffic across the interconnected zone.

The topology is based on the “2×2 Attached” scenario as shown in FIG. 4. The abbreviations used in FIG. 5 are as follows (the corresponding references of FIG. 4 are provided in parenthesis):
M: master node (node 303);
D: deputy node (node 304);
S1: slave node (node 305);
S2: slave node (node 306).

A column 505 indicates various states, wherein the Traffic Gateways are the nodes at the edges of respective paths. For example, row 521 shows a scenario connecting the nodes M and S1, hence these nodes are the traffic gateways.

An upper row 520 depicts the possible failures and recovery states that may affect the nodes and the links over which traffic is forwarded.

Columns 506 to 517 show a full-meshed scenario according to FIG. 4 (i.e. all nodes are connected). Columns 518 and 519 refer to a scenario in which the master node and the deputy node are not directly connected via an internal port.

FIG. 6 shows a flow chart illustrating data flows and the transitions between the flows that may result from different failures. An ellipse 601 indicates the starting point of the state diagram.

### Packet Structure

A IEEE 802.1ag protocol can be extended as follows: A link-level Continuity Check Message (CCM) may be provided with a new TLV (type/length/value field), which is used to communicate the forwarding conditions of a node and a port per VLAN.

This TLV can be included in the link-level CCM that is generated by the ports, which are controlled by the TFC. Each port may create the TLV according to its state. This TLV may be named “TFC TLV” and it may comprise a type field amounting to “9” (which corresponds to the first available value in table 21-6 of IEEE 802.1ag). The structure of the TFC TLV is: Type=9; Length=1024 and values.

For each VLAN, two bits can be allocated in the TLV to indicate the forwarding conditions of the node and port for this VLAN:
The first bit indicates the node's forwarding condition for the VLAN. A value “0” indicates that the node is in the “standby” forwarding condition and does not forward traffic in the VLAN. The value “1” indicates that the node is in the “active” forwarding condition and is ready to forward traffic in the VLAN.
The second bit indicates the forwarding condition of the port regarding the VLAN. The value “0” indicates that the port is in the “standby” forwarding condition and does not forward traffic in the VLAN. The value “1” indicates that the port is in the “active” forwarding condition and forwards traffic in the VLAN.

The first two bits in the TFC TLV indicate the information relating to VLAN number 1. The next two bits in the TFC TLV indicate the status relating to VLAN number 2, and so on until VID 4096. This structure may be similar to the structure used in IEEE 802.1ak MVRP (Multiple VLAN Registration Protocol). In this case, only two bits are used per VLAN in contrast to the MVRP which uses three bits per VLAN.

In case of untagged traffic, the first two bits may indicate the status of the entire traffic.

FIG. 7 shows a proposed structure for the TFC TLV based on IEEE 802.1ag CCM.

The protocol according to IEEE 802.1ag is used for fault management purposes and it may be used over an interface. When CCM messages are used to detect a fault condition or a failure and trigger protection switching, a transmission rate for CCM messages may be set to 3.3 ms. Thus, the loss of three CCM messages (used to trigger a protection switching event) can be detected within 10.8 ms. Using CCM messages to communicate the forwarding conditions per VLAN between peer ports may thus ensure that a fault condition in an interconnected zone can be promptly detected and a protection switching in less than 50 ms can be achieved.

For this application, a message may have to be defined or an existing message (format) need to be adapted. This may be relevant also when the concept discussed herein is applied to technologies other than the Ethernet. Such a message may preferably provide information with regard to all services required.

### Further Advantages

The solution provided herewith enables a fast recovery mechanism (in particular within less than 50 ms) protecting any type of Carrier Ethernet service against a fault condition or failure or degradation in an Ethernet protection domain.

It is noted that the approach described may apply to other scenarios as Carrier Ethernet as well.

The mechanism provided is applicable to the “2×2 Attached” scenario, the “Full Mesh 2×2 Attached” scenario, the “1×2 Attached” scenario and the “Full Mesh1×2 Attached” scenario. The respective interconnected zones can be protected accordingly.

Each attached network may utilize a different packet trans-port technology (e.g., Ethernet according to IEEE 802.1ah or according to IEEE 802.1ad, MPLS-TP, L2-MPLS, etc.), which uses its own resiliency mechanism to protect network operation. The mechanism described herein in combination with such resiliency mechanisms implemented in the attached network enable the immediate detection of any type of facility (node or interface) failure or degradation. Following the detection of a failure or degradation, network operation can be rapidly restored. This provides full compliance with the terms of the SLA guaranteed for the end-to-end Carrier Ethernet service that is delivered over the interconnected networks.

The mechanism defined herein supports internal links that connect two nodes in the same attached network. The purpose of these links is to preserve the Traffic Gateways and to minimize the effects of protection events in the interconnected zone on the topology of the attached networks.

This mechanism may be based on Ethernet Connectivity Fault Management according to IEEE 802.1ag supplemented by enhancements applied to the Continuity Check protocol to allow the communication of the protection states between the nodes in the interconnected zone. The information on the protection states can be added to the CCM packets. This allows rapid fault detection and coordination of the protection state in order to perform fast protection switching when required.

It is noted, however, that the concept described does not have to be based on IEEE 802.1ag. Other messaging techniques could be applied as well. It could be advantageous to have one message (type or format) that allows conveying forwarding conditions for several (or in particular all) services.

Network survivability is a critical factor in the delivery of reliable Carrier Ethernet services. Carrier Ethernet services are worldwide services which traverse inter-domain, intercarrier and inter-packet-technology networks as well as national and global networks. Access networks provide availability over fiber, copper, cable, passive optical networks (PONs) and wireless interfaces to a large amount of customers. Carrier Ethernet services enable economy of scale from converged business, residential and wireless networks, which share the same infrastructure and services and which are capable of rapidly deploying different kinds of applications while retaining the cost model and advantages of the Ethernet.

Carrier Ethernet services bring compelling business benefits to enterprises, with sectors such as healthcare, finance, education, government, media, etc., and with applications like site-to-site access, business continuity, disaster recovery, or the like.

Carrier Ethernet services are also used for mobile backhauling with applications for voice, video and data economically satisfying the demands for spiraling bandwidth that are currently constrained by the prohibitive costs of legacy (e.g. TDM) networks. Carrier Ethernet services provide the reliability, complete SLA support and full OAM capabilities required for mobile backhauling applications. Reliability is a key requirement for these applications as well as for residential services and entertainment applications.

Using the mechanism described herein, carriers may provide the required level of end-to-end resiliency when supplying Carrier Ethernet services over interconnected networks that comply with the terms of the respective SLA.

### List of Abbreviations:

### B-VLAN Backbone VLAN

### CCM Continuity Check Message

### C-VLAN Customer LAN

### E-LAN Ethernet LAN

### E-Line Ethernet Line

### EPL Ethernet Private Line

### EP-LAN Ethernet Private LAN

### EP-Tree Ethernet Private Tree

### ETH Ethernet

### E-Tree Ethernet Tree

### ETY Ethernet Physical Layer

### EVPL Ethernet Virtual Private Line

### EVP-LAN Ethernet Virtual Private LAN

### EVP-Tree Ethernet Virtual Private Tree

### FDB Filtering Data Base

### GFP Generic Framing Procedure

### IEEE Institute of Electrical and Electronics Engineers

### IETF Internet Engineering Task Force

### IP Internet Protocol

### LAG Link Aggregation

### LAN Local Area Network

### MA Maintenance Association

### MAC Media Access Control

### MEF Metro Ethernet Forum

### MEP Maintenance End Point

### MPLS Multiprotocol Label Switching

### MPLS-TP MPLS-Transport Profile

### MVRP Multiple VLAN Registration Protocol

### OAM Operation Administration Maintenance

### SLA Service Level Agreement

### S-VLAN Service VLAN

### TFC Traffic Forwarding Controller

### TLV Type/Length/Value

### VID VLAN ID

### VLAN Virtual LAN

### VPLS Virtual Private LAN Service

WDM Wavelength Division Multiplexing

1.-17. (canceled)

18. A method for conveying traffic, the method comprising:
providing a master node connected to a first slave node and to a second slave node;
the first slave node and the second slave node having a direct connection;
conveying traffic between the master node and the first slave node; and
in case of a fault condition, conveying the traffic between the master node and the first slave node via the second slave node and via the direct connection between the first slave node and the second slave node.

19. The method according to claim 18, wherein the master node is connected via a first port to the first slave node and via a second port to the second slave node.

20. The method according to claim 18, which comprises triggering with the second slave node a decision to become an intermediate node for conveying the traffic.

21. The method according to claim 18, wherein the master node is associated with a first network and the first and second slave nodes are associated with a second network.

22. The method according to claim 18, wherein
a deputy node is connected to the first slave node and to the second slave node; and
in the case of the fault condition the deputy node takes over for the master node.

23. The method according to claim 22, wherein the master node and the deputy node are directly and/or indirectly connected.

24. The method according to claim 22, wherein the master node and the deputy node each comprise three interfaces as follows:
a working interface connected to the first slave node;
a protection interface connected to the second slave node; and
an internal interface.

25. The method according to claim 24, wherein the master node or the deputy node pursuant to the fault condition conveys traffic by switching over from the working interface to the protection interface or from the protection interface to the working interface.

26. The method according to claim 18, which comprises, after the fault condition is over, conveying the traffic as it was conveyed prior to the occurrence of the fault condition.

27. The method according to claim 18, wherein the fault condition comprises, or is based on, a failure or degradation of an interface or node.

28. The method according to claim 27, wherein the fault condition is at least one condition selected from the group consisting of:
a link failure;
an interface failure;
a remote interface failure;
a remote node failure; and
an administrative operation.

29. The method according to claim 18, which comprises conveying traffic via a virtual local area network.

30. The method according to claim 18, which comprises conveying a portion of traffic via a separate virtual local area network.

31. The method according to claim 18, wherein the traffic is an Ethernet traffic.

32. The method according to claim 18, wherein the traffic is an Ethernet traffic comprising Ethernet frames.

33. The method according to claim 18, which comprises determining the fault condition with the master node, with the deputy node or with a slave node.

34. A communication device, comprising, or associated with, at least one device selected from the group consisting of a processor unit, a hard-wired circuit, and a logic device configured to execute thereon the method according to claim 18.

35. The communication device according to claim 34, formed as a network element associated with the network or an edge node of the network.

36. A communication system, comprising the device according to claim 34.
